(19) United States
(12) Patent Application Publication
(10) Pub. No.: US 2012/0125050 A1
(43) Pub. Date: May 24, 2012

(54) METHOD FOR MANUFACTURING GLASS PLATE

(75) Inventor: Tsugunobu Murakami, Yokkaichi-shi (JP)

(73) Assignee: AVANSTRATE INC., Yokkaichi-shi, Mie (JP)

(21) Appl. No.: 13/383,789

(22) PCT Filed: Sep. 29, 2011
(86) PCT No.: PCT/JP2011/072471

§ 371 Date: Jan. 12, 2012

(30) Foreign Application Priority Data
Sep. 30, 2010 (JP) 2010-223083

(51) Int. Cl. C03B 5/225; C03B 5/43; C03B 17/06

(52) U.S. Cl. 65/90; 65/134.3

(57) ABSTRACT

A method for manufacturing a glass plate includes preparing an accommodating part made of platinum or a platinum alloy, fining molten glass of a melted feedstock, stirring and homogenizing the molten glass, and supplying the molten glass to a forming apparatus. The fining the molten glass includes causing gas bubbles to float up and out from the molten glass, and causing absorption of the gas component in the molten glass and eliminating gas bubbles. The water vapor partial pressure of an atmosphere in the causing the gas bubbles is lower than the water vapor partial pressure in at least a portion of the causing the absorption of the gas component. A boundary between the causing the gas bubbles and the causing the absorption of the gas component is a temperature lower than the maximum temperature by 30° C. or more after the molten glass has reached the maximum temperature.

### TECHNICAL FIELD

The present invention relates to a method for manufacturing a glass plate.

### BACKGROUND ART

Flat glass plates are currently used as components of display parts for flat panel displays such as liquid crystal display devices and plasma display devices. In the case of a liquid crystal display device for example, the glass plate is used as a glass substrate constituting a thin-film-transistor liquid crystal display device (TFT-LCD), as well as a cover glass for covering the display part. In the case of a glass substrate, a glass that can prevent degradation of TFT characteristics caused by deposition of alkali metal ions and a glass that can ease a differential in the coefficient of thermal expansion relative to a silicon film which is formed during TFT formation are used.

Heretofore, glass manufacturers have been concerned about formation of gas bubbles in the glass during the manufacturing process. An extremely low gas bubble content is required particularly for thin glass plates used as glass substrates or cover glasses for liquid crystal display devices. In order to eliminate gas bubbles in the glass manufacturing process, arsenic oxide or antimony oxide has been used as a fining agent added to the glass feedstock. However, due to concern for the environmental impact of these fining agents, reduction in their use has become a social imperative. Accordingly, various other methods for eliminating gas bubbles have been sought.

Practitioners of the art have come to appreciate empirically that as one cause of gas bubble formation, molten glass of high viscosity at high temperature is formed on an interface between the molten glass and glass plate manufacturing devices, such as pipes and vessels made of fire-resistant metals such as platinum or the like. Also, it is commonly suggested that this may be due to hydrogen ions (H⁺) or hydrogen in the molten glass migrating through the platinum. Specifically, if the partial pressure of hydrogen outside the wall made of platinum or platinum alloy is lower than the partial pressure of hydrogen inside the wall, hydrogen ions (H⁺) or hydrogen (H₂) originating from water molecules (H₂O) in the molten glass inside the wall migrate to the outside through the wall of platinum or platinum alloy. Meanwhile, due to the aforedescribed migration of hydrogen ions (H⁺) or hydrogen (H₂), O₂ is generated from hydroxide ions (OH) originating from water molecules (H₂O) in the molten glass, and forms gas bubbles in areas in proximity to the interface between the platinum or platinum alloy and the molten glass inside the wall. Consequently, in order to prevent gas bubbles from forming, the partial pressure of hydrogen outside the pipe of platinum or a platinum alloy or the vessel of platinum or a platinum alloy should be higher than the partial pressure of hydrogen inside the pipe or the vessel. One method for increasing the partial pressure of hydrogen on the outside is to supply water vapor to the atmosphere on the outside for humidification. From experience, practitioners of the art have come to appreciate that manufacturing glass in a high-humidity environment makes it less likely for gas bubbles to form in the glass.

For example, Patent Document 1 (JP-A No. 2001-503008) discloses a technique for controlling the partial pressure of hydrogen outside a vessel of fire-resistant metal such as platinum or the like, relative to the partial pressure of hydrogen inside the vessel. Also, Patent Document 2 (JP-A No. 2008-539162) discloses a technique for dividing the space around a vessel into two spaces and hermetically sealing the spaces, and individually controlling the partial pressure of hydrogen in each of the hermetically sealed spaces.

### SUMMARY OF THE INVENTION

### Technical Problem

However, there is a concern that if the humidity of the atmosphere around manufacturing equipments is higher than necessary, shortened service life, as well as of increased power consumption, of the manufacturing equipments may occur. In the technique disclosed in Patent Document 2, there is no clear method for establishing the boundaries of the two hermetically sealed spaces around the vessel.

With the foregoing in view, the present invention provides a method for manufacturing a glass plate whereby gas bubbles in the glass can be effectively minimized, while increasing the service life and reducing power consumption of the manufacturing equipments.

### Solution to Problem

As a result of carrying out intensive research regarding a method for suppressing the formation of gas bubbles in glass, the inventors of the present invention ascertained that:

(i) moisture in glass being manufactured sometimes increases due to moisture contained in recycled glass cullet admixed into the glass feedstock;

(ii) if the amount of moisture in glass increases, migration of the hydrogen ions in the molten glass to the platinum or platinum alloy wall is more likely to occur, and if the hydrogen partial pressure is increased in the atmosphere around the platinum or platinum alloy vessel in order to suppress the migration, it becomes necessary to supply more water vapor to the atmosphere, hence there is a vicious circle as to the relationship between the supply of water vapor to the atmosphere and the suppression of formation of gas bubbles in the glass;

(iii) it is necessary to attain a balance between increase in the amount of moisture contained in the glass and decrease in strength of glass which occurs as a tradeoff;

(iv) in a state of relatively high partial pressure of water vapor in the atmosphere surrounding an accommodating part made of platinum or a platinum alloy, and of a temperature of the molten glass high enough to be appropriate for fining, the β-OH value within the molten glass tends to rise, with a risk of adverse effects on fining of the glass;

(v) excessive supply of water vapor around a heating device comprising a furnace for melting the feedstock can reduce the service life of glass manufacturing apparatus; and

(vi) because the accommodating part loses heat through contact with water vapor, in some cases, unnecessary supply of water vapor inhibits heating of the molten glass, and more power than necessary will be needed to heat the molten glass.

The present invention was perfected upon discovering that, as a procedure for minimizing or ameliorating all of these causes in a glass manufacturing device, it is effective to efficiently control the atmosphere in the vicinity of a specific accommodating part which is a region provided with an accommodating part made of platinum or a platinum alloy, in other words, to supply water vapor to the atmosphere in the vicinity of the specific, accommodating part, in a manner dependent on the stage of fining; and that as a result of doing so, formation of gas bubbles in glass can be suppressed more effectively. Herein, “accommodating part” is a concept that includes both vessels and pipes.

Specifically, the method for manufacturing a glass plate pertaining to the present invention comprises a fining step for fining molten glass resulting from melting of feedstock; a homogenizing step for stirring and homogenizing the molten glass; and a supply step for supplying the molten glass to a forming apparatus; the series of steps being carried out within an accommodating part made of platinum or a platinum alloy. The fining step includes a first step for causing gas bubbles to float up and eliminating the bubbles from the molten glass within a first temperature range in which a fining agent included in the feedstock releases a gas component; and a second step following the first step, for causing absorption of the gas component in the molten glass and eliminating gas bubbles at a lower temperature than the maximum temperature of the first temperature range. The partial pressure of water vapor in the atmosphere surrounding the accommodating part in the first step is lower than the partial pressure of water vapor in the atmosphere surrounding the accommodating part in at least a part of the second step. The boundary between the first step and the second step is a temperature lower than the maximum temperature by 30° C. or more after the molten glass has reached the maximum temperature.

According to the method for manufacturing a glass plate pertaining to the present invention, it is possible to identify the boundary of a first step and a second step by the temperature of the molten glass. The first step is the step in which the water vapor partial pressure in the atmosphere surrounding the accommodating part must be low. The second step is the step in which the water vapor partial pressure in the atmosphere in question must be high. Because of this, while avoiding adverse effects on glass manufacturing equipment and on fining of the glass due to supply of unnecessary water vapor into the atmosphere, an unintended drop in temperature of the accommodating part can be prevented, and the power needed to heat the molten glass can be reduced. Consequently, according to the method for manufacturing a glass plate of the present invention, gas bubbles in the glass can be effectively minimized, while increasing the service life of the manufacturing equipment is attained.

Moreover, in the method for manufacturing a glass plate pertaining to the present invention, it is desirable that in the first step, water vapor is not supplied to the atmosphere surrounding the accommodating part; and in at least a part of the second step, water vapor is supplied to the atmosphere surrounding the accommodating part.

Moreover, in the method for manufacturing a glass plate pertaining to the present invention, it is desirable that in the first step, an enclosure for enclosing the accommodating part is furnished, and the partial pressure of water vapor in the atmosphere surrounding the accommodating part inside the enclosure is lowered below the partial pressure of water vapor in the atmosphere outside the enclosure.

Moreover, in the method for manufacturing a glass plate pertaining to, the present invention, it is desirable that the fining agent is tin oxide (SnO₂), and the first temperature range is from 1610° C. to 1700° C.

Moreover, in the method for manufacturing a glass plate pertaining to the present invention, it is desirable that the fining agent is sodium sulfate (Na₂SO₄), and the first temperature range is, from 1500° C. to 1520° C.

Moreover, the method for manufacturing a glass plate pertaining to the present invention comprises a fining step for fining molten glass of a completely melted feedstock; a homogenizing step for homogenizing the molten glass; and a supply step for supplying the molten glass to a device for forming. At least one of the series of the steps is carried out within an accommodating part made of platinum or a platinum alloy. The method for manufacturing a glass plate of the present invention is characterized in that controlling a partial pressure of water vapor in atmosphere surrounding the accommodating part. The accommodating part in question accommodates the molten glass whose temperature being at or below temperature T2 which is 50° C. below a maximum point T1 after having reached the maximum point T1 in the series of the steps. Moreover, the accommodating part accommodates the molten glass, and is a concept that includes both vessels and pipes.

According to the method for manufacturing a glass plate pertaining to the present invention, from the temperature of the molten glass, it is possible to identify an accommodating part made of platinum or a platinum alloy, for which the control of the atmosphere is necessary. Specifically, the partial pressure of water vapor in the atmosphere surrounding an accommodating part made of platinum or a platinum alloy is controlled. The accommodating part in question accommodates the molten glass whose temperature is at or below a temperature T2 which is 50° C. below a temperature T1, and is downstream from a region where it reached T1 which is its maximum temperature in the fining step, the homogenizing step, and the supply step. Thus, atmosphere surrounding an accommodating part made of platinum or a platinum alloy which needs to be supplied with water vapor to suppress the formation of gas bubbles in the glass is identified. Then, through supply of water vapor to the atmosphere surrounding the identified accommodating part, the partial pressure of water vapor on the outside of the accommodating part can be increased with respect to the partial pressure on the inside, and formation of gas bubbles in the glass can be effectively suppressed.

Moreover, it is desirable that the method for manufacturing a glass plate pertaining to the present invention further comprises a forming step for forming the molten glass into a plate; and in the forming step, the molten glass is formed into a plate by an overflow downdraw process.

### Advantageous Effect of Invention

According to the method for manufacturing a glass plate pertaining to the present invention, gas bubbles in the glass can be effectively minimized, while increasing the service life and reducing power consumption of manufacturing apparatus is attained.

### BRIEF DESCRIPTION OF THE DRAWINGS

FIG. 1 is a flowchart of the method for manufacturing a glass plate according to the present invention.

FIG. 2 is a schematic view of a glass plate manufacturing apparatus according to an embodiment of the present invention.

FIG. 3 is a graph showing a glass temperature gradient in the steps of glass plate manufacture according to an embodiment of the present invention.

FIG. 4 is a generalized view of a planar face of part of the glass plate manufacturing apparatus according to an embodiment of the present invention.

FIG. 5 is a graph showing a glass temperature gradient in the steps of glass plate manufacture according to a modified example of an embodiment of the present invention.

FIG. 6 is a generalized view of a side face of part of the glass plate manufacturing apparatus according to an embodiment of the present invention.

FIG. 7 is a generalized view of a side face of part of the glass plate manufacturing apparatus according to a modified example of an embodiment of the present invention.

### DESCRIPTION OF EMBODIMENTS

The method for manufacturing a glass plate according to an embodiment of the present invention is described in detail below.

### (1) OVERALL CONFIGURATION

### (1-1) Overview of Glass

The glass plate manufactured by the method for manufacturing a glass plate of the present embodiment is liquid crystal substrate glass, which is used as a glass substrate in display devices such as liquid crystal display devices and the like. However, as will be shown below, application is also possible for glasses other than liquid crystal substrate glass. Liquid crystal substrate glass refers to glass that includes substantially no alkali metal oxides, or that contains alkali metal components in a range such that there is no degradation of TFT characteristics in a liquid crystal display device, and specifically, to glass having a total concentration of the alkali metal oxides represented as Na₂O, K₂O, or Li₂O of 2.0 mass % or less.

In the present embodiment, while a method of fabricating liquid crystal substrate glass is described as an example of the method for manufacturing a glass plate, no limitation is provided thereby. For example, the method for manufacturing a glass plate of the present embodiment is applicable as well in cases of fabricating reinforced glass substrates. As examples of reinforced glass substrates, there may be cited cover glass for mobile telephones, digital cameras, PDAs, and solar cells, as well as cover glass for touch panel displays, but no limitation is provided thereby.

The feedstock of the liquid crystal substrate glass according to the present embodiment has, for example, the following composition:

(a) SiO₂: 50 to 70 mass %

(b) B₂O₃: 5 to 18 mass %

(c) Al₂O₃: 10 to 25 mass %

(d) MgO: 0 to 10 mass %

(e) CaO: 0 to 20 mass %

(f) SrO: 0 to 20 mass %

(o) BaO: 0 to 10 mass %

(p) RO: 5 to 20 mass % (R is at least one selected from Mg, Ca, Sr, and Ba)

(q) R′₂O: 0 to 2.0 mass % (R′ is at least one selected from Li, Na, and K)

(r) A total of 0.05 to 1.5 mass % of at least one metal oxide selected from tin oxide, iron oxide, and cerium oxide.

The aforedescribed liquid crystal substrate glass contains substantially no arsenic or antimony. That is, even if these substances are included, they represent impurities, specifically, these substances constitute 0.1 mass % or less, inclusive of the oxides As₂O₃ and Sb₂O₃.

In addition to the above-mentioned components, the glass of the present invention may also contain various other oxides in order to adjust various physical, melting, fining, and forming characteristics of the glass. As examples of such other oxides, without limitation, there may be cited SnO₂, TiO₂, MnO, ZnO, Nb₂O₅, MoO₃, Ta₂O₅, WO₃, Y₂O₃, and La₂O₃. In the present embodiment in particular, tin oxide (SnO₂) is used as a fining agent for facilitating fining of the glass.

A nitrate or a carbonate can be used as the supply source for the RO of (p) in the above listed composition (a) through (r). In order to increase the oxidation of the molten glass, it is desirable to use nitrate as the supply source of RO in a proportion suitable to the step of the glass manufacture.

The glass plate manufactured in the present embodiment is manufactured continuously, which differs from the glass manufactured by a batch process in which a given amount of glass feedstock is supplied to a melting furnace. The glass plates applicable to the manufacturing method of the present invention may be glass plates of any desired thickness and width.

In the present embodiment, gas bubbles, which are counted in terms of a bubble defect rate (the number of gas bubbles contained per 1 kg of glass), refer to gas bubbles of bubble size of 100 μtm or greater, for example. Gas bubbles in the molten glass are not limited to those of spherical shape; gas bubbles may be elongated in one direction and of flat elliptical shape. In such cases, gas bubbles of a maximum dimension of 100 μm or greater in the elongated direction are counted as defects. As shall be apparent, gas bubbles smaller than 100 μm are not permitted to persist either.

### (1-2) Overview of Glass Manufacturing Steps

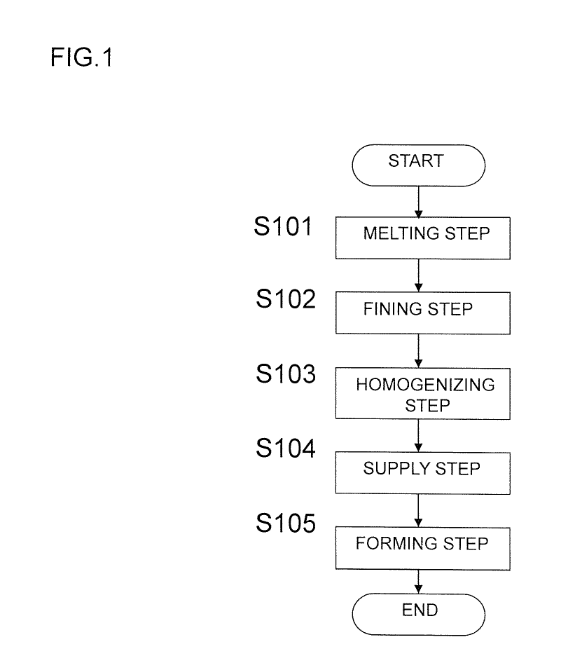

FIG. 1 shows a flowchart of an example of the method for manufacturing a glass plate according to the embodiment of the present invention. As shown in FIG. 1, the method for manufacturing glass has a melting step (Step S101), a fining step (Step S102), a homogenizing step (Step S103), a supply step (Step S104), and a forming step (Step S105).

The melting step (Step S101) is a step for melting the glass feedstock. The glass feedstock charged to the furnace is heated and melted. The completely melted glass feedstock becomes molten glass, and flows out to the accommodating part where the next step, i.e., the fining step (Step S102), is carried out.

The fining step (Step S102) is a step for fining the molten glass. Specifically, it is step whereby gas components contained in the molten glass are removed through vaporization or as gas bubbles. The fined molten glass flows out to the accommodating part where the next step, i.e., the homogenizing step (Step S103), is carried out.

The homogenizing step (Step S103) is a step for homogenizing the molten glass. In this step, temperature regulation of the molten glass for which fining has been done is carried out as well. The molten glass is homogenized by stirring. In this step, if gas components in the molten glass form gas bubbles, these will persist in the glass and will not be removed, so formation of gas bubbles must be avoided. The homogenized molten glass flows out to the accommodating part where the next step, i.e., the supply step (Step S104), is carried out.

The supply step (Step S104) is a step for supplying the molten glass to the device for forming the glass into a sheet. In this step, the molten glass is cooled to a temperature suitable for forming. In this step as well, if gas components in the molten glass form gas bubbles, these will persist in the glass and will not be removed, so formation of bubbles must be avoided. The molten glass flows out to the device where the following forming step (Step S105) is carried out.

The forming step (Step S105) is a step for forming the molten glass into a glass sheet. In the present embodiment, the molten glass is continuously formed into a sheet by an overflow downdraw process discussed below. The glass formed into a sheet to be cut into glass plates.

### (1-3) Overview of Glass Manufacturing Apparatus

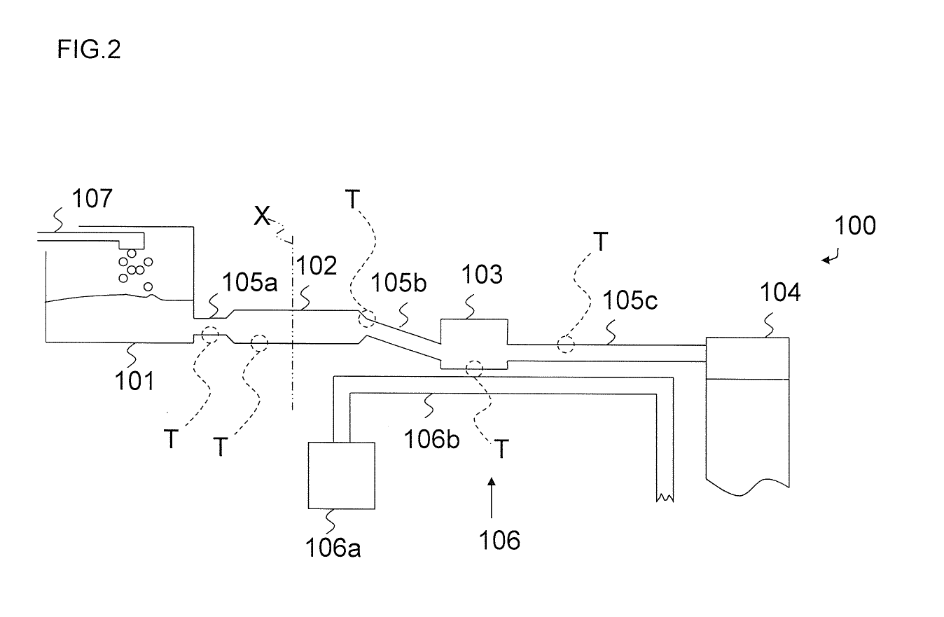

FIG. 2 shows an example of a glass plate manufacturing apparatus 100 according to an embodiment of the present invention. The glass plate manufacturing apparatus 100 has a melting bath 101, a fining vessel 102, a stirring vessel 103, a forming apparatus 104, conduit pipes 105a, 105b, 105c, and a humidifying device 106. The accommodating part is inclusive of the fining vessel 102, the stirring vessel 103, and the conduit pipes 105a, 105b, 105c.

The melting bath 101 comprises a lower part termed a liquid vessel, and an upper part space, which are composed of a refractory such as brick or the like. A burner for combusting gases such as a fuel and oxygen or the like to produce a flame is furnished on the wall face of the upper part space. The burner heats the refractory constituting the upper part space with the combusted gases, whereupon the glass feedstock is heated and melted by the radiant heat produced by the high-temperature refractory. The liquid vessel is furnished with an electric heating device for passing current through the molten glass thereby generating Joule heat from the molten glass itself. The wall face of the liquid vessel is furnished with electrodes of the electric heating device in such a way as to contact the molten glass. In the present embodiment, the electrodes are made of tin oxide (SnO₂). The melting step (Step S101) is carried out in the melting bath 101.

The fining vessel 102 comprises a pipe made of platinum or a platinum alloy, for containing the molten glass. The fining vessel 102 is furnished with an electric heating device for heating the molten glass flowing in the pipe. Flange-shaped electrodes of the electric heating device, which are made of platinum or a platinum alloy, are attached to the pipe. Applying an electric current to the electrodes and passing the current through the pipe, the pipe radiates heat, and the Joule heat thereof heats the molten glass in the pipe. The fining step (Step S102) is carried out in the fining vessel 102.

The stirring vessel 103 comprises a vessel made of platinum or a platinum alloy for containing the molten glass; a rotating shaft made of platinum or a platinum alloy; and a plurality of stirring blades made of platinum or a platinum alloy, attached to the rotating shaft. The rotating shaft is inserted vertically into the vessel from the top part of the vessel. The plurality of stirring blades are attached to the rotating shaft in radial fashion centered on the rotating shaft. The rotating shaft is rotated by a driving part such as a motor or the like. As the rotating shaft rotates, the plurality of stirring blades attached to the rotating shaft stir the molten glass. The homogenizing step (Step S103) is carried out in the stirring vessel 103.

The forming apparatus 104 comprises a forming body that is open in its upper part, and that has a generally pentagonal shape in cross-section in the vertical direction. The forming body is a refractory such as zircon or the like. The forming apparatus 104 also comprises a roller for downwardly stretching the molten glass which has overflowed from the forming body and converged at the distal end of the bottom of the forming body and a cooling device for gradually cooling the glass, and so on. The forming step (S105) is carried out in the foaming apparatus 104.

The conduit pipes 105a, 105b, 105c are pipes made of platinum or a platinum alloy, and are equipped with power source equipment for passing current thereto. Flange-shaped electrodes made of platinum or a platinum alloy are attached to the conduit pipes 105a, 105b, 105c. When an electric current applied to the electrodes and the current pass through the conduit pipes 105a, 105b, 105c, the conduit pipes 105a, 105b, 105c radiate heat, and the Joule heat thereof heats the molten glass in the conduit pipes 105a, 105b, 105c.

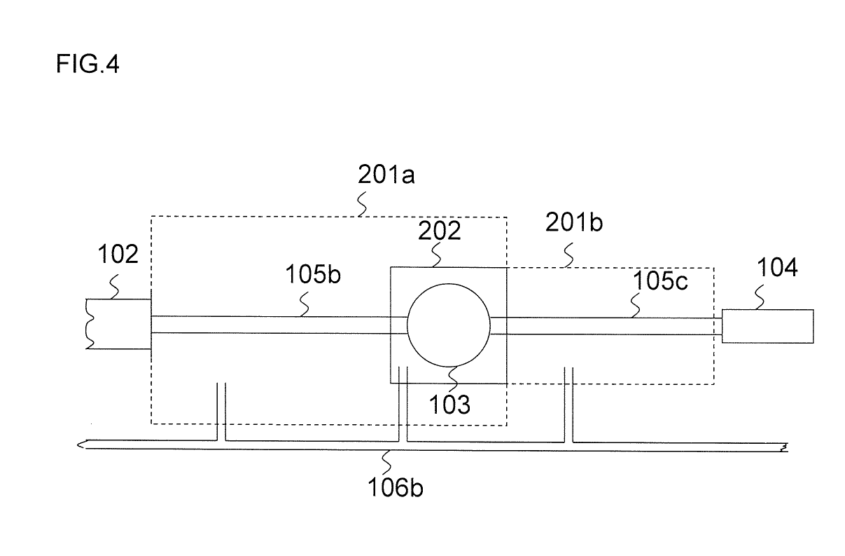

The humidifying device 106 comprises a boiler 106a for evaporating water to generate water vapor, and a water vapor pipe 106b for supplying water vapor. FIG. 4 shows a plan view of part of the glass plate manufacturing apparatus 100 of the present embodiment. An enclosure 201 a made of a tin plate is furnished surrounding the conduit pipe 105b and the stirring vessel 103, and the water vapor pipe 106b supplies water vapor to the atmosphere in the enclosure 201a. The stirring vessel 103 is enclosed by an outer wall 202 of brick, and the water vapor pipe 106b supplies water vapor to the atmosphere between the outer wall 202 and the stirring vessel 103 as well. The surroundings of the conduit pipe 105c are also furnished with an enclosure 201b made of a tin plate, and the water vapor pipe 106b supplies water vapor to the atmosphere in the enclosure 201 b as well.

### (2) DETAILED OF MOLTEN GLASS TEMPERATURE CONTROL AND ATMOSPHERE CONTROL

### (2-1) Temperature Control

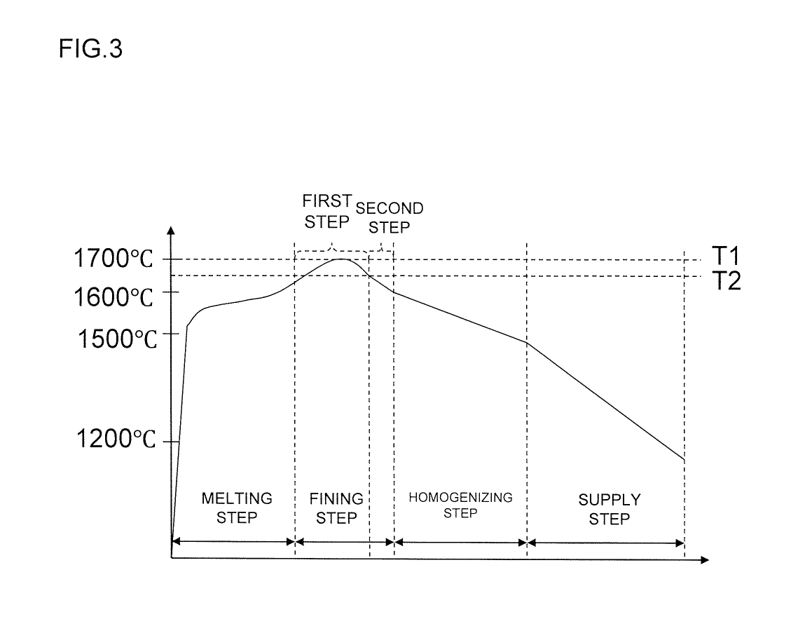

FIG. 3 shows a glass temperature gradient in the series of steps of the glass plate manufacturing method according to the present embodiment. The temperature of the molten glass is derived by measured values of thermometers (thermocouples) disposed at positions shown by T in FIG. 2. The thermometers, by virtue of being disposed in proximity to the outer wall of the accommodating part or contacting the outer wall of the accommodating part, measure temperatures of the accommodating part, and the temperatures of the molten glass are derived on the basis of the temperatures thereof. Temperatures of the molten glass between thermometers can be derived through estimation of a temperature gradient. The sites for disposition of the thermometers are not limited to those shown in FIG. 2, and by disposing thermometers at more sites, temperature changes can be measured more accurately.

The liquid crystal substrate glass according to the present embodiment has a melting point of 1500° C. or above. Consequently, the glass feedstock is heated to approximately 1550° C. or above in the melting bath 101. The heated glass feedstock melts. The completely melted glass feedstock becomes molten glass, and flows out from the melting bath 101.

Next, in the fining step (Step S102), the molten glass which has flowed out from the melting bath 101 is heated further to a temperature suitable for fining. In the fining step, gas bubbles in the molten glass are eliminated in the course of the next two stages.

In a first stage (herein designated as the first step), the fining agent emits a gas component generating gas bubbles in the molten glass, whereupon these gas bubbles incorporate the surrounding gas component and float up, thereby eliminating gas bubbles in the molten glass. Specifically, in the first step, the molten glass is heated to a maximum temperature in the fining step (T1 in FIG. 3) as shown in FIG. 3. As the temperature of the molten glass rises, the viscosity falls, and the lower viscosity makes it easier for gas bubbles to escape from the molten glass. Also, an oxidation-reduction reaction of oxides contained in the glass feedstock proceeds due to heating to a temperature suitable for fining, whereby oxygen ions are readily released, agglomerate with other gas components contained in the glass feedstock to generate gas bubbles, and are readily eliminated from the molten glass.

The maximum temperature in the aforedescribed fining step is determined with consideration to various parameters. For example, the maximum temperature in the fining step is favorably a temperature at which the glass feedstock melts completely. That is, selection of the maximum temperature in the fining step is dependent on the glass composition being obtained. Also, the maximum temperature in the fining step is favorably a temperature close to an upper limit of a temperature range in which the fining agent, discussed below, exhibits the fining action thereof, or a temperature exceeding this upper limit. Further, the maximum temperature in the fining step is desired not to be a higher temperature than necessary. The reason is that if the maximum temperature is a high temperature exceeding 1700° C., there may be increased volatilization or the like of the platinum or platinum alloy component of the vessel, shortening the life of the, vessel. Specifically, while the maximum temperature in the fining step is dependent on the glass composition being obtained as well, a temperature in a range of from about 1610° C. to about 1700° C. for example, is favorable. By heating the molten glass to such a temperature, the aforementioned action of eliminating gas bubbles proceeds efficiently, and fining action is exhibited. The maximum temperature in the fining step is the highest temperature of the molten glass in the fining step (Step S102) and the subsequent steps; namely the temperature is the highest temperature of the molten glass downstream of the melting bath 101.

By using a fining agent, fining of the molten glass can be promoted by facilitating the generation of gas bubbles through agglomeration of gas components contained in the glass feedstock, and releasing the gas bubbles to the outside from the molten glass. For example, in the present embodiment, tin oxide can be used as a fining agent. At high temperature, tin oxide emits oxygen by the reaction SnO₂→SnO+½O₂⇑, and this reaction can proceed efficiently in a temperature range of from about 1610° C. to about 1680° C. to 1700° C. (first temperature range).

On the other hand, in a second stage (herein designated as the second step), gas contained in gas bubbles that persist in the molten glass becomes dissolved or absorbed into the molten glass, and the gas bubbles disappear. Specifically, in the second step, the temperature of the molten glass, which in the aforementioned first step was heated until reaching the aforedescribed maximum temperature, is gradually brought down. In the process of this drop in temperature, the pressure of the gas dissolved in the glass drops. As a result, the persisting gas bubbles become smaller and some of them vanish. Also, as the temperature drops, the aforedescribed oxygen emission reaction produced by the fining agent proceeds in the opposite direction, and the gas bubbles shrink as a result of chemical lysis of the gas components thereof.

Next, the homogenizing step (Step S103) begins from the time that the temperature of the molten glass has been brought down to about 1600° C. to 1560° C. The molten glass is then cooled to, about 1500° C. in this step.

Next, in the supply step (Step S104), the temperature of the molten glass is cooled to a temperature suitable for forming the glass. In the case of the alkali-free glass according to the present embodiment, the temperature suitable for forming is about 1200° C. Consequently, the molten glass is cooled to a temperature of 1200° C. in the conduit pipe 105c just before flowing into the forming apparatus 104.

### (2-2) Atmosphere Control

Atmosphere control is carried out in order to suppress formation of gas bubbles and persistence of the gas bubbles in the molten glass, particularly in areas in proximity to the interface of the molten glass and the accommodating part. The atmosphere control refers to control of the partial pressure of water vapor in the atmosphere surrounding the accommodating part. Specifically, water vapor is supplied to the atmosphere surrounding the accommodating part, and the temperature of the atmosphere is controlled with an air conditioner, a heater, or the like, so that the partial pressure of water vapor on the outside of the accommodating part made of platinum or a platinum alloy is higher than that on the inside. As absolute humidity by weight=(molecular weight of water <18.015>×partial pressure of water vapor)/(average molecular weight of dry atmosphere <29.064>×(total atmospheric pressure−partial pressure of water vapor)), the partial pressure of water vapor can be derived by measuring the temperature, humidity, and total atmospheric pressure in the atmosphere. The control of the supply of water vapor is done by increasing or reducing the weight per unit of time, of water contained in the water vapor supplied from the device that supplies water vapor to the outside of the accommodating part. Additionally, in order to adjust the water vapor partial pressure inside the accommodating part, adjustment of moisture contained in the glass feedstock is carried out as well. Because of this, generation of O₂ from hydroxide ions (OH⁻) in the molten glass due to migration of hydrogen ions (H⁺) or hydrogen (H₂) to the outside from the inside of the accommodating part made of platinum or a platinum alloy can be minimized, and formation of gas bubbles in the molten glass, and particularly in areas in proximity to the interface with the accommodating part, can be suppressed.

Identification of the accommodating part, or a region thereof, where this atmosphere control should be carried out is extremely important in terms of effectively fining the molten glass. Of the glass manufacturing apparatus, a region in which the first step of the aforementioned fining step is to be carried out will be a region in which the gas component in the molten glass must be actively caused to form gas bubbles so that the gas bubbles may be emitted and eliminated from the molten glass. Consequently, as mentioned above, in such a region, the molten glass is heated until reaching the maximum temperature in the fining step, and the viscosity of the molten glass is lowered, so that the gas component readily escapes from the molten glass. On the other hand, in the steps downstream from the first step, which include the aforementioned second step, the temperature of the molten glass is gradually brought down, and consequently the viscosity of the molten glass increases, and it becomes difficult for the gas component in the molten glass to escape. As a result, in cases where gas bubbles have formed in the molten glass in a step downstream from the first step, some of the gas bubbles may not be absorbed into the molten glass, and may persist in the glass plate after forming. Consequently, in the steps downstream from the first step, the atmosphere surrounding at least part of the accommodating part made of platinum or a platinum alloy is favorably supplied with water vapor to increase the partial pressure of water vapor outside the accommodating part relative to the partial pressure of water vapor inside the accommodating part, to minimize the generation of O₂ from hydroxide ions (OH⁻) in the molten glass, and to minimize the formation of gas bubbles in the molten glass, particularly in areas in proximity to the interface with the accommodating part.

Meanwhile, it is not necessary to supply water vapor into the atmosphere surrounding the accommodating part in which the first step is proceeding; conversely, supplying water vapor will inhibit escape of the gas component from the molten glass. Also, if there is a large amount of water vapor in the atmosphere in the first step, heat will be lost from the accommodating part to the water vapor, and more power than necessary will be needed in order to heat the molten glass to a temperature suitable for fining. For example, in some cases the temperature of the molten glass may drop to around 1600° C. due to supply of water vapor to the atmosphere surrounding the accommodating part, and in such cases, power of at least about 3.26 kW or more will be necessary in order to raise the temperature of the molten glass by, e.g., approximately 12° C. Additionally, even more power is needed in consideration of the heat lost to water vapor. Moreover, in the first step of fining, if the partial pressure of water vapor in the atmosphere surrounding the accommodating part is relatively high and in a high temperature range suited to fining of the molten glass, the β-OH value in the molten glass will easily rise, giving adverse effects on fining action.

For the reasons discussed above, it is important to establish a boundary between a step in which water vapor should be supplied into the atmosphere, and a step in which water vapor should not be supplied. The boundary in question is the boundary between the first step and the second step of the fining step, and as mentioned above, because the first step and the second step proceed in a manner dependent on the temperature of the molten glass, it is favorable to identify the boundary in question by the temperature of the molten glass. The boundary between the first step and the second step of the fining step is then set to a temperature lower by a predetermined temperature than the maximum temperature reached by the molten glass in the series of the steps comprising the fining step (Step S102) and the subsequent steps, after the maximum temperature in question (T1 of FIG. 3) has been reached. For example, a temperature lower by 30° C. or more after the molten glass has reached the maximum temperature of the fining step may be designated as the boundary of the first step and the second step. For example, a temperature lower by 30° C. to 70° C., or a temperature lower by 40° C. to 60° C., after the molten glass has reached the maximum temperature in the fining step can be designated as the boundary of the first step and the second step. In particular, it is favorable to identify a temperature lower by 50° C. (T2 of FIG. 3) as the boundary of the first step and the second step. That is, temperatures of the molten glass at positions in the accommodating part containing the molten glass are obtained on the basis of molten glass temperatures measured by the thermometers or a molten glass temperature gradient estimated from measured temperatures. Thus, a position in the accommodating part which corresponds to the position where the temperature of the molten glass declines by a predetermined temperature after having reached the maximum temperature in the fining step can be determined. The position derived in this manner can be designated as the boundary of the first step and the second step. The reason for clearly defining the boundary of the first step and the second step in this manner is as follows.

As mentioned previously, the temperature of the molten glass is measured by thermometers furnished on the surface of the accommodating part, or in proximity thereto. However, in actuality, a temperature gradient exists in the molten glass within the platinum vessel. Also, the molten glass is constantly flowing. Further, in some cases, degradation of the thermometers over time may lead to measurement errors on the order of 10° C. to 30° C. Consequently, it is difficult to accurately measure temperature changes of the molten glass smaller than 30° C. On the other hand, if the temperature drop subsequent to the molten glass having reached the maximum temperature is greater than 30° C. to 70° C., it is highly likely that the second step of the fining step has been reached. For this reason, lowering the partial pressure of water vapor in the atmosphere surrounding the accommodating part containing the molten glass whose temperature has reached the maximum temperature in steps comprising the fining step (Step S102) and subsequent steps and then has dropped more than 30° C. to 70° C. may possibly inhibit dissipation of gas bubbles in the molten glass. Consequently, it may be contemplated to designate, as the boundary of the first step and the second step, a temperature lower by 30° C. to 70° C. than the maximum temperature subsequent to the molten glass having reached the maximum temperature in steps comprising the fining step (Step S102) and subsequent steps; and to thereby maximize the power reduction effect and the gas bubble minimizing effect. Also, in the first step of fining, most of the gas component is emitted from the tin oxide before the molten glass reaches the maximum temperature. Because of this, the fining effect afforded by the gas bubbles floating up is largely accomplished prior to the temperature of the molten glass reaching the maximum temperature in steps comprising the fining and subsequent steps and then dropping 30° C. from that maximum temperature. Also, if the temperature of the molten glass drops by 30° C. or more from the maximum temperature after having reached the maximum temperature in steps comprising the fining step and subsequent steps, for example, by 30° C. to 70° C., by 40° C. to 60° C., or by 50° C., the fining effect afforded by the gas bubbles floating up will have been sufficiently accomplished. Also, in cases where the glass feedstock contains 0.13 to 0.23 mass % tin oxide, at a temperature lower by 50° C. than the maximum temperature after the molten glass temperature has reached the maximum temperature, the remaining tin oxide will have been sufficiently reduced in quantity for there to be no effect on devitrification of the glass. For the reasons above, supply of water vapor to the atmosphere in the surroundings of the accommodating part can be carried out at a point downstream from a region of the accommodating part contacting molten glass at a temperature lower by 30° C. or more, for example, by 30° C. to 70° C. or by 40° C. to 60° C., from the maximum temperature after having reached the maximum temperature in steps comprising the fining step (Step S102) and subsequent steps. In the present embodiment, water vapor is supplied to the atmosphere surrounding the accommodating part at a point downstream from a region (X in FIG. 2) of the accommodating part contacting molten glass at a temperature lower by 50° C. after having reached the maximum temperature in the fining step. Because of this, adverse effects of water vapor on the glass manufacturing equipment and on the first step of fining can be suppressed, waste of power can be suppressed and the molten glass can be fined effectively, and persistence of gas bubbles in the glass can be effectively suppressed.

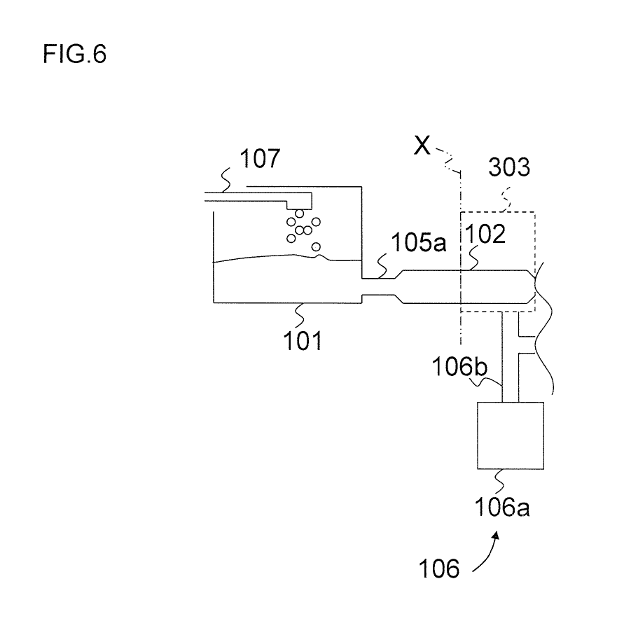

In the present embodiment, the temperature of the molten glass is about 1600 to 1560° C. at the point in time of outflow from the fining vessel 102 after having reached the maximum point of about 1700 to 1610° C. in steps comprising the fining step (Step S102) and subsequent steps. Consequently, an enclosure 201 a of a tin plate is disposed surrounding the conduit pipes 105b, 105c and the stirring vessel 103, and water vapor is supplied to the atmosphere in the enclosure 201a at a pressure of about 3 to 7 kPa. The atmosphere inside the brick outer wall 202 enclosing the stirring vessel 103 is supplied with water vapor at a pressure of about 3 kPa. Also, the atmosphere in the tin enclosure 201b surrounding the conduit pipe 105c is supplied with water vapor at a pressure of about 1 to 13 kPa as well. The partial pressure of water vapor on the outside of the accommodating part made of platinum or a platinum alloy is higher than that on the inside. The atmosphere in these enclosures 201a, 201b is controlled to be at an air temperature of about 35 to 40° C., and humidity of 50% or higher. As mentioned previously, in the fining vessel 102, a position at which the temperature of the molten glass has dropped by 30° C. or more from the maximum temperature after having reached the maximum temperature in the fining step, for example, by 30° C. to 70° C., by 40° C. to 60° C., or by 50° C., can be designated as the boundary X of the first step and the second step. As shown in FIG. 6, a portion downstream from the aforedescribed boundary X of the fining vessel 102 may be furnished with an enclosure 303 with a tin plate, and water vapor may be supplied into the enclosure 303 in the same manner as into the aforedescribed enclosures 201a, 201b. The portion to the upstream side of the aforedescribed boundary X of the fining vessel 102 need not be furnished with an enclosure. Alternatively, the portion upstream of the aforedescribed boundary X of the fining vessel 102 may be enclosed by a plate of tin so that the water vapor supplied to downstream of the aforedescribed boundary X will not enter into the enclosure upstream from the aforedescribed boundary X. In a case where the portion to the upstream side of the aforedeseribed boundary X is furnished with an enclosure, the inside of the enclosure may be dehumidified. In so doing, the partial pressure of water vapor in the atmosphere outside the accommodating part can be lowered below the partial pressure of water vapor inside the accommodating part, and bubble-formation in the molten glass can be promoted to advance fining through gas bubbles floating up in the first step. Through the aforedescribed method, the partial pressure of water vapor in the atmosphere surrounding the accommodating part in the first step can be lowered below the partial pressure of water vapor in the atmosphere surrounding the accommodating part in at least a portion of the second step.

### (3) FINING EFFECT

As set forth above, according to the method for manufacturing a glass plate of the present invention, the number of gas bubbles included in a glass plate can be effectively suppressed. Also, according to the method for manufacturing a glass plate of the present invention, it is anticipated that the moisture content of the glass, represented by the β-OH value, can be kept to a lower level as compared with a case where an accommodating part whose surrounding atmosphere to be supplied with water vapor has not been identified.

This effect is based on the following experimental results.

First, the components needed to manufacture glass containing SiO₂: 60.9 mass %, B₂O₃: 11.6 mass %, Al₂O₃: 16.9 mass %, MgO: 1.7 mass %, CaO: 5.1 mass %, SrO: 2.6 mass %, BaO: 0.7 mass %, K₂O: 0.25 mass %, Fe₂O₃: 0.15 mass %, and SnO₂: 0.13 mass % were combined, and molten glass was prepared according to the temperature gradient of FIG. 3. Next, using the glass plate manufacturing apparatus 100 shown in FIG. 2 and implementing an overflow downdraw process, this molten glass was subjected to a fining step, a homogenizing step, a supply step, and a forming step to manufacture a glass plate. As mentioned previously, atmosphere control during this time involved supplying water vapor respectively at pressure of about 6 kPa to the atmosphere in the tin plate enclosure 201a enclosing the conduit pipe 105b and the stirring vessel 103; at pressure of about 3 kPa to the atmosphere in the brick outer wall 202 enclosing the stirring vessel 103; and at pressure of about 9 kPa to the atmosphere in the tin enclosure 201b surrounding the conduit pipe 105c. The atmosphere in these enclosures 201a, 201b was controlled to be at an air temperature of about 35 to 40° C., and humidity of 50% or higher.

Sampling of this glass plate was carried out 14 times while varying the time interval, and the number of gas bubbles contained in the glass plate was counted. The result was that in one example only, the glass plate contained 0.2 gas bubbles per kilogram, whereas in the other examples, the glass plate contained 0 gas bubbles per kilogram.

Meanwhile, a glass plate was manufactured using a device identical to the glass plate manufacturing apparatus 100 according to the present embodiment, but not employing the method for manufacturing a glass plate according to the present invention. Specifically, no water vapor was supplied to the atmosphere surrounding the accommodating part that is made of platinum or a platinum alloy, and that accommodates molten glass at a temperature of about 1600° C. to 1560° C. or below, after the temperature of the molten glass had reached a maximum point of about 1700 to 1610° C. (T1) in the fining step (Step S102), the homogenizing step (S103), or the supply step (S104). Sampling of a glass plate obtained in the same manner as the aforedescribed was carried out 14 times while varying the time interval, and the number of gas bubbles contained was counted. The result was that the minimum number of gas bubbles contained per kilogram of the glass plate was 0.8. At most, the number was 9.2. On average, the number of gas bubbles per kilogram of the glass plate was 3.65.

As discussed, previously, with the method for manufacturing a glass plate according to the present invention, by an extremely simple procedure of enclosing the surroundings of the vessels and the conduit pipes with plates of tin, atmosphere control can be carried out without increased complexity of manufacturing equipment, and the supply of water vapor to regions furnished with equipment sensitive to water vapor can be blocked, whereby it is possible to prolong the life of the manufacturing equipment.

### (4) CHARACTERISTICS

### (4-1)

In the aforedescribed embodiment, the fining step (S102) includes a first step in which the molten glass is heated to a predetermined temperature of 1610° C. to 1700° C., and gas bubbles are deliberately caused to form from a gas component in the molten glass and thereby eliminate the gas component from the molten glass; and a subsequent second step in which the gas component is caused to be absorbed into the molten glass from gas bubbles persisting in the molten glass, causing the gas bubbles to disappear. The predetermined temperature in question is the maximum temperature in the fining step, the homogenizing step, and the supply step, that is, during and subsequent to fining. The boundary X of the first step and the second step is a temperature lower by 30° C. or more than the maximum temperature after the molten glass has reached the maximum temperature in the fining step, for example, by 30° C. to 70° C., by 40° C. to 60° C., or by 50° C. For example, a region of the fining vessel 102 in contact with molten glass at a temperature lower by 50° C. after having reached the maximum temperature is identified as the boundary X of the first step and the second step. Water vapor is then supplied to the atmosphere surrounding at least a portion of the region of the fining vessel 102 where the second step proceeds. Water vapor is not supplied to the atmosphere surrounding the region of the fining vessel 102 where the first step proceeds. Also, the surroundings of the region of the fining vessel 102 where the first step proceeds is not furnished with a tin plate, but is open. Because of this, generation of gas bubbles in the molten glass is not inhibited by the water vapor supplied to downstream of the aforedescribed boundary X, and the first step of fining can be carried out without delay. That is, the partial pressure of water vapor on the outside of the accommodating part can be made lower than that on the inside, or prevented from becoming higher than necessary; and emission of gas components such as oxygen and the like from in the molten glass will not be suppressed. Also, loss of heat from the accommodating part due to water vapor in the first step can be minimized, and as a result, unnecessary consumption of power can be suppressed. Also, a rise in the β-OH value of the molten glass in the first step can be suppressed, and adverse effects on fining action can be suppressed. Consequently, adverse effects on glass manufacturing equipment by water vapor can be suppressed, the molten glass can be fined effectively, and persistence of gas bubbles in the glass can be effectively suppressed.

### (4-2)

The method for manufacturing a glass plate in the aforedescribed embodiment includes a fining step (Step S102) for fining molten glass of a completely melted feedstock; a homogenizing step (Step S103) for homogenizing the molten glass; and a supply step (Step S104) for supplying the molten glass to the forming apparatus 104. At least one of this series of steps is carried out in an accommodating part made of platinum or an alloy thereof The method for manufacturing a glass plate in the aforedescribed embodiment is characterized in that controlling the partial pressure of water vapor, in the atmosphere by supplying water vapor to the surroundings of an accommodating part made of platinum or a platinum alloy, and containing molten glass at a temperature of about 1600 to 1560° C., after the temperature of the molten glass has reached a maximum temperature of about 1700 to 1610° C. (T1) in this series of steps. Here, 1600 to 1560° C. is equal to or less than 1650 to 1560° C. (T2) which is 50° C. lower than T1.

In the method for manufacturing a glass plate according to the aforedescribed embodiment, it is possible, from the temperature of the molten glass, to identify an accommodating part made of platinum or a platinum alloy and requiring atmosphere control. That is, it is sufficient to control the partial pressure of water vapor in the atmosphere surrounding the accommodating part made of platinum or a platinum alloy and containing molten glass at or below T2 which is a temperature lower by 30° C. or more than a maximum point T1, for example, by 30° C. to 70° C., by 40° C. to 60° C., or by 50° C., at a point downstream of the region in which the temperature of the molten glass has reached T1 in the fining step (Step S102), the homogenizing step (Step S103), the supply step (Step S104), or the forming step (Step S105). In so doing, there may be identified an accommodating part made of platinum or a platinum alloy, and requiring that water vapor be supplied to the atmosphere thereof, in order to suppress formation of gas bubbles in the glass. Then, by supplying water vapor to the atmosphere surrounding the identified accommodating part, the partial pressure of water vapor on the outside of the accommodating part can be made higher than that on the inside, and formation of gas bubbles in the glass can be effectively suppressed. Also, it is anticipated that the amount of moisture in the glass, as represented by the β-OH value, can be reduced to a lower level, as compared with a case where an accommodating part whose atmosphere is to be supplied with water vapor has not been identified.

### (5) MODIFIED EXAMPLES

### (5-1) Modified Example A

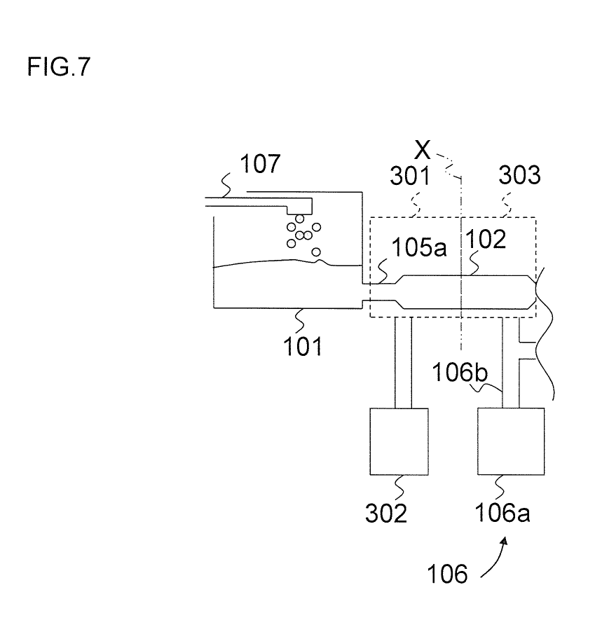

In the aforedescribed embodiment, the partial pressure of water vapor is controlled through supply of water vapor to the atmospheres surrounding a portion of the fining vessel 102; the conduit pipes 105b, 105c; and the stirring vessel 103, which carry out the second step of the fining step (Step S102), the homogenizing step (Step S103), and the supply step (Step S104). However, in another embodiment, in addition to this, the atmosphere surrounding the fining vessel 102 which carries out the fining step may controlled as follows. That is, the boundary X of the first step and the second step is identified as discussed above, and the partial pressure of water vapor in the atmosphere surrounding the region of the fining vessel 102 where the first step is carried out is lowered to below the partial pressure of water vapor in the atmosphere surrounding the portion of the fining vessel 102 where the second step is carried out. Specifically, for example, in the portion of the fining vessel 102 where the first step is carried out, an enclosure 301 of tin or the like enclosing the region is furnished as shown in FIG. 7. The atmosphere inside the enclosure 301 is dehumidified by a dehumidifier 302, lowering the partial pressure of water vapor in the atmosphere inside the enclosure to below the partial pressure of water vapor in the atmosphere outside the enclosure. Also, water vapor is supplied to the atmosphere surrounding the portion of the fining vessel 102 where the second step is carried out, so as to increase the water vapor partial pressure. The surroundings of the portion of the fining vessel 102 where the second step is carried out may be enclosed by an enclosure 303 of tin or the like, and water vapor supplied to the inside of the enclosure.

In so doing, fining of the molten glass can be carried out effectively, and problems occurring due to water vapor in the atmosphere surrounding the region of the accommodating part where the above-described first step is carried out can be suppressed. That is, the need for more power than necessary in order to heat the molten glass to a temperature suitable for fining, due to loss of heat from the accommodating part through contact with water vapor in the first step, can be suppressed. Also, adverse effects on fining action due to a rise in β-OH concentration in the molten glass can be minimized. Also, adverse effects on devices which are susceptible to humidity can be suppressed, and prolonging the service life of the glass manufacturing apparatus 100 can be attained. Further, fining action through gas bubbles floating up in the molten glass in the first step can be improved.

### (5-2) Modified Example B

In the aforedescribed embodiment, the glass manufactured using the method for manufacturing a glass plate pertaining to the present invention is liquid crystal substrate glass. However, in another embodiment, the method for manufacturing glass plate according to the present invention may be used to manufacture another glass plate. For example, the method may be used to manufacture cover glass that contains an alkali metal oxide. In this case, the aforedescribed embodiment would be modified as follows.

The glass according to the present modified example contains an alkali metal oxide. Specifically, the total concentration of an alkali metal oxide represented by Na₂O, K₂O, or Li₂O in the glass is greater than 2.0 mass %.

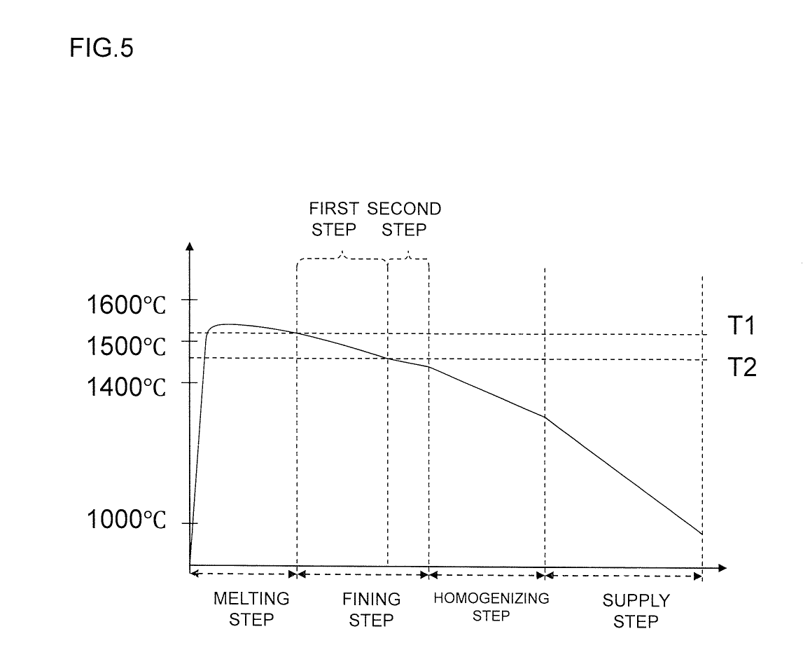

FIG. 5 shows a temperature gradient of glass in a series of steps of a method for manufacturing glass plate according to the present modified example.

In the melting step (Step S101), the glass feedstock according to the present modified example is heated to about 1530° C., and melted.

In the fining step (Step S102), the molten glass is heated until reaching around 1520 to 1500° C. The temperature of molten glass suitable for fining is a range of about 1520 to 1470° C., The fining step (Step S102) continues to the terminus of the fining vessel 102. The temperature of the molten glass flowing out from the fining vessel 102 is about 1470 to 1450° C. In this fining step (Step S102) in particular, it is preferable to facilitate fining action more effectively in the temperature range of the first half of the fining step (Step S102), and to do so, it is preferable, for example, to add sodium sulfate (Na₂SO₄) as a fining agent to the glass feedstock.

The second step of the fining step (Step S102) starts at the time that the molten glass reaches about 1470 to 1450° C. Then, in the next homogenizing step (Step S103), the molten glass is cooled to about 1350° C.

In the supply step (Step S104), the molten glass is further cooled to about 1000° C.

In the present modified example, water vapor is supplied to humidify the atmosphere in the vicinity of the conduit pipes 105b, 105c and the stirring vessel 103 containing molten glass at or below about 1470 to 1450° C. (T2) which is lower by 30° C. or more than the maximum temperature of about 1520 to 1500° C. (T1), for example, by 30° C. to 70° C., by 40° C. to 60° C., or by 50° C., after the temperature of the molten glass has reached the maximum temperature T1 in the fining step (Step S102), the homogenization step (S103), or the supply step (Step S104).

Consequently, in the method for manufacturing glass plate according to the present modified example, it is preferable to use sodium sulfate (Na₂SO₄) as a fining agent for the molten glass, and for T1 to be 1500 to 1520° C.

### REFERENCE SIGNS LIST

100 glass plate manufacturing apparatus
101 melting bath
102 fining vessel (accommodating part)
103 stirring vessel (accommodating part)
104 forming apparatus
105a, 105b, 105c conduit pipe (accommodating part)
106 humidifying device

### CITATIONS LIST

### Patent Literature

Patent Document 1: JP-A No. 2001-503008

Patent Document 2: JP-A No. 2008-539162

1. A method for manufacturing a glass plate, comprising:
preparing an accommodating part made of platinum or a platinum alloy;
fining molten glass of a melted feedstock;
stirring and homogenizing the molten glass; and
supplying the molten glass to a forming apparatus,
the fining the molten glass including
causing gas bubbles to float up and out from the molten glass within a first temperature range in which a fining agent included in the feedstock releases a gas component, and
causing absorption of the gas component in the molten glass and eliminating gas bubbles at a lower temperature than the maximum temperature of the first temperature range, after the causing the gas bubbles to float up and out from the molten glass;
the water vapor partial pressure of an atmosphere surrounding the accommodating part in the causing the gas bubbles to float up and out from the molten glass being lower than the water vapor partial pressure of the atmosphere surrounding the accommodating part in at least a portion of the causing the absorption of the gas component in the molten glass and the eliminating the gas bubbles,
a boundary between the causing the gas bubbles to float up and out from the molten glass and the causing the absorption of the gas component in the molten glass and the eliminating the gas bubbles being a temperature lower than the maximum temperature by 30° C. or more after the molten glass has reached the maximum temperature.

2. The method for manufacturing the glass plate as recited in claim 1, wherein
in the causing the gas bubbles to float up and out from the molten glass, water vapor is not supplied to the atmosphere surrounding the accommodating part, and
in at least a portion of the causing the absorption of the gas in the molten glass and the eliminating the gas bubbles, water vapor is supplied to the atmosphere surrounding the accommodating part.

3. The method for manufacturing the glass plate as recited in claim 1, wherein
in the causing the gas bubbles to float up and out from the molten glass, an enclosure for enclosing the accommodating part is furnished, and the partial pressure of water vapor in the atmosphere surrounding the accommodating part inside the enclosure is reduced to below the partial pressure of water vapor in the outside air outside the enclosure.

4. The method for manufacturing the glass plate as recited in claim 1, wherein
the fining agent is tin oxide (SnO₂), and the first temperature range is from 1610° C. to 1700° C.

5. The method for manufacturing the glass plate as recited in claim 1, wherein
the fining agent is sodium sulfate (Na₂SO₄), and the first temperature range is from 1500° C. to 1520° C.

6. A method for manufacturing a glass plate comprising:
preparing an accommodating part made of platinum or a platinum alloy;
fining molten glass of a completely melted feedstock;
homogenizing the molten glass;
supplying the molten glass to a forming apparatus; and
controlling a partial pressure of water vapor in atmosphere surrounding the accommodating part accommodating the molten glass of which temperature is at or below temperature T2 which is 50° C. below a maximum temperature T1 after having reached the maximum point T1 in a process including the fining the molten glass, the homogenizing the molten glass, and the supplying the molten glass.

7. The method for manufacturing the glass plate as recited in claim 1, further comprising
forming the molten glass into a sheet, wherein
the molten glass is formed into a sheet by an overflow downdraw process.

8. The method for manufacturing the glass plate as recited in claim 6, further comprising
forming the molten glass into a sheet, wherein
the molten glass is formed into a sheet by an overflow downdraw process.
